(19) United States
(12) Patent Application Publication
(10) Pub. No.: US 2026/0303483 A1
(43) Pub. Date: Oct. 1, 2026

(54) Methods And Systems For Managing Application Programming Interfaces Using A Network Of Artificial Intelligence Agents

(71) Applicant: Google LLC, Mountain View, CA (US)

(72) Inventor: Abhishek Garg, Bengaluru (IN)

(21) Appl. No.: 19/249,113

(22) Filed: Jun. 25, 2025

(30) Foreign Application Priority Data
Mar. 31, 2025 (IN) 202541031517

(51) Int. Cl. H04L 41/5009; G06F 40/30; H04L 41/0631; H04L 67/63

(52) U.S. Cl. CPC H04L 41/5009; G06F 40/30; H04L 41/0631; H04L 67/63

(57) ABSTRACT

The disclosed technology is directed to apparatus, a system and a method for managing application programming interfaces (APIs) using a network of artificial intelligence (AI) agents. The disclosed technology enables efficient API management by utilizing multiple specialized AI agents working collaboratively, rather than a single agent approach. These agents obtain and analyze API metadata and runtime data to monitor performance, perform compliance checks, and determine root causes through dependency graph analysis. The system maps runtime data to API metadata, performs compliance checks, and enables specialized agents to collaborate through shared memory or storage. When users submit queries, user-facing agents determine their intent and route them to appropriate specialized agents, providing comprehensive insights into API health, potential issues, and their root causes.

### BACKGROUND

Management of application programming interfaces (APIs) involves controlling access, enforcing policies, monitoring usage, etc. However, such API management can be resource intensive and time consuming. For example, in enforcing policies, it can be difficult to detect whether a policy is being violated. As another example, monitoring usage can be labor intensive, requiring manual review and analysis of data.

### BRIEF SUMMARY

Aspects of the disclosure are directed to apparatus, a system and a method for managing application programming interfaces (APIs) using a network of artificial intelligence (AI) agents. The disclosed technology enables efficient API management by utilizing multiple specialized AI agents working collaboratively, rather than a single agent approach. These agents obtain and analyze API metadata and runtime data to monitor performance, detect service level objective (SLO) violations, and determine root causes through dependency graph analysis. The system maps runtime data to API metadata, performs compliance checks, and enables specialized agents to collaborate through shared memory. When users submit queries, user-facing agents determine their intent and route them to appropriate specialized agents, providing comprehensive insights into API health, potential issues, and their root causes.

An aspect of the disclosure provides for a method for managing APIs using a network of one or more AI agents, the method including: obtaining, with one or more processors by the network of one or more AI agents, API metadata for a plurality of APIs from an API hub; obtaining, with the one or more processors, API runtime data indicating actual performance metrics of the plurality of APIs; mapping, with the one or more processors, the API runtime data to corresponding API metadata; performing, with the one or more processors, compliance checks by identifying differences between API performance specified in the API metadata and actual performance; and generating, by the one or more processors, a response based on analysis of the compliance check.

In an example, the network of AI agents comprises a plurality of specialized AI agents, each specialized AI agent being configured to perform a specific function for managing API.

In another example, the method further includes determining, with the one or more processors, SLO violations based on the identified differences between the API performance specified in the API metadata and the actual performance.

In yet another example, the method further includes calculating, with the one or more processors, dependency for APIs identified as violating SLOs; and analyzing, with the one or more processors, the dependency to determine root causes of the SLO violations.

In yet another example, the method further includes storing, in a shared memory accessible by the plurality of specialized AI agents, results of the compliance checks and analysis. In yet another example, the shared memory enables information sharing between the plurality of specialized AI agents in a cascading manner, wherein output from one AI agent serves as input to another agent.

In yet another example, the method further includes receiving, with the one or more processors, a user query related to API performance; determining, with the one or more processors, an intent of the user query using a user-facing AI agent within the network of AI agents; and routing, with the one or more processors, the user query to an appropriate specialized AI agent within the network based on the determined intent.

In yet another example, the API metadata comprises at least one of API specifications, policies, expected response times, availability requirements, security requirements, or dependency information. In yet another example, the API runtime data comprises at least one of error rates, actual response times, traffic volume, availability metrics, or security incidents.

In yet another example, the compliance checks include at least one of policy compliance verification, dependency analysis, or root cause analysis of performance issues.

Another aspect of the disclosure provides for system for managing APIs, the system including: one or more processors; and a memory storing instructions that, when executed by the one or more processors, cause the system to implement a network of AI agents configured to: obtain API metadata for a plurality of APIs from an API hub; obtain API runtime data indicating actual performance metrics of the plurality of APIs; map the API runtime data to corresponding API metadata; perform compliance checks by identifying differences between API performance specified in the API metadata and actual performance; and generate a response based on analysis of the compliance check.

In an example, the network of AI agents comprises a plurality of specialized AI agents, each specialized AI agent being configured to perform a specific function for managing API.

In another example, the specialized AI agents include a policy compliance agent configured to determine SLO violations based on the identified differences between the API performance specified in the API metadata and the actual performance.

In yet another example, the specialized AI agents include an analysis agent configured to calculate dependency for APIs identified as violating SLOs; and analyze the dependency to determine root causes of the SLO violations.

In yet another example, the network of AI agents is further configured to store results of the compliance checks and analysis in a shared memory accessible by the plurality of specialized AI agents. In yet another example, the shared memory enables information sharing between the plurality of specialized AI agents in a cascading manner, wherein output from one AI agent serves as input to another agent.

In yet another example, the specialized AI agents include a user-facing agent configured to: receive a user query related to API performance; determine an intent of the user query using a user-facing AI agent within the network of AI agents; and route the user query to an appropriate specialized AI agent within the network based on the determined intent.

In yet another example, the API metadata comprises at least one of API specifications, policies, expected response times, availability requirements, security requirements, or dependency information. In yet another example, the API runtime data comprises at least one of error rates, actual response times, traffic volume, availability metrics, or security incidents.

In yet another example, the compliance checks include at least one of policy compliance verification, dependency analysis, or root cause analysis of performance issues.

### BRIEF DESCRIPTION OF THE DRAWINGS

FIG. 1 depicts a block diagram of an example system involving mapping runtime data to specific API entities according to aspects of the disclosure.

FIG. 2 is a schematic diagram depicting agents configured for a compliance check according to aspects of the disclosure.

FIG. 3 is a schematic diagram depicting agents configured for dependency graph analysis according to aspects of the disclosure.

FIG. 4 is a schematic diagram depicting an example configuration of user facing agent according to aspects of the disclosure.

FIG. 5 depicts a flow diagram of an example process of managing application programming interfaces (APIs) for a compliance check according to aspects of the disclosure.

FIG. 6 depicts a block diagram of an example computing environment implementing an example process of managing APIs using a network of artificial intelligence (AI) agents according to aspects of the disclosure.

### DETAILED DESCRIPTION

A plurality of agents may be configured for various uses cases, such as policy compliance, dependency graph analysis, or user-facing operations. Each agent may execute one or more artificial intelligence (AI) models. With respect to policy compliance, the plurality of agents may determine which APIs are violating service level objectives (SLOs) based on runtime and API metadata. With respect to dependency graph analysis, the plurality of agents may determine the root cause of APIs violating SLOs. With respect to user-facing operations, the agents may execute a rule that requires traversal over API metadata, execute a rule/policy that requires traversal over API metadata and the runtime data, or utilize some specific entity for consumption.

API Hub is a centralized repository that stores and manages metadata, specifications, documentation, and related information for all APIs within a cloud environment. It serves as a central platform allowing API developers, consumers, and administrators to discover available APIs, review API specifications and manage API-related policies.

### Policy Compliance

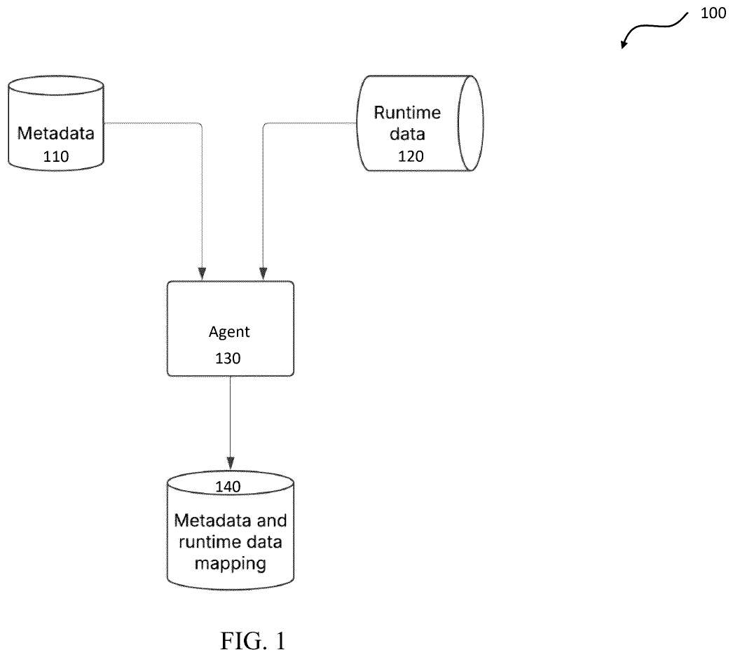

The plurality of AI agents may carry out policy checks and flag APIs that are failing to comply. In some examples, a user may want to identify the APIs that are violating their SLOs. SLOs are metadata attributes within the plurality of agents. Both metadata and runtime data can be used to ascertain whether the APIs are meeting their SLOs. As illustrated in FIG. 1, the architecture of such a system 100 may involve mapping runtime data to specific API entities and then running the required compliance checks by iterating over API metadata and the associated runtime data. The mapping process has a time complexity of O(n*m), where ‘n’ represents the number of APIs in the plurality of agents and ‘m’ represents the count of runtime data blocks. The agent can check the compatibility of each pair and store the mapping if they are determined to correspond. This process can be deterministic if the mapping rules are straightforward.

One of the plurality of AI agents can be configured to collect metadata 110 for all relevant APIs from the API Hub. For example, the metadata 110 can be collected by a metadata agent of the plurality of AI agents. This metadata can include at least one of API specifications, defined SLOs, expected performance metrics, and other design-time characteristics. Simultaneously, one of the plurality of AI agents can be configured to collect runtime data 120 from actual API calls. The collected runtime data 120 can include at least one of response times, throughput rates, error rates, request and response payloads, and other performance indicators.

One of the plurality of AI agents 130 can perform the mapping process between each API's metadata 110 and its corresponding runtime data 120. This mapping process can elaborate on the time complexity of O(n*m), where ‘n’ represents the number of APIs and ‘m’ represents the count of runtime data blocks. The agent performs the mapping process 130 can evaluate whether each API meets its defined SLOs by comparing metadata attributes with runtime measurements. During this mapping process, the agent 130 can use algorithms to connect runtime data to the correct API entities through API identifiers, endpoint paths, or other unique characteristics. Since multiple APIs may share similar characteristics, the agent 130 may apply various matching rules to ensure the accuracy of these mappings.

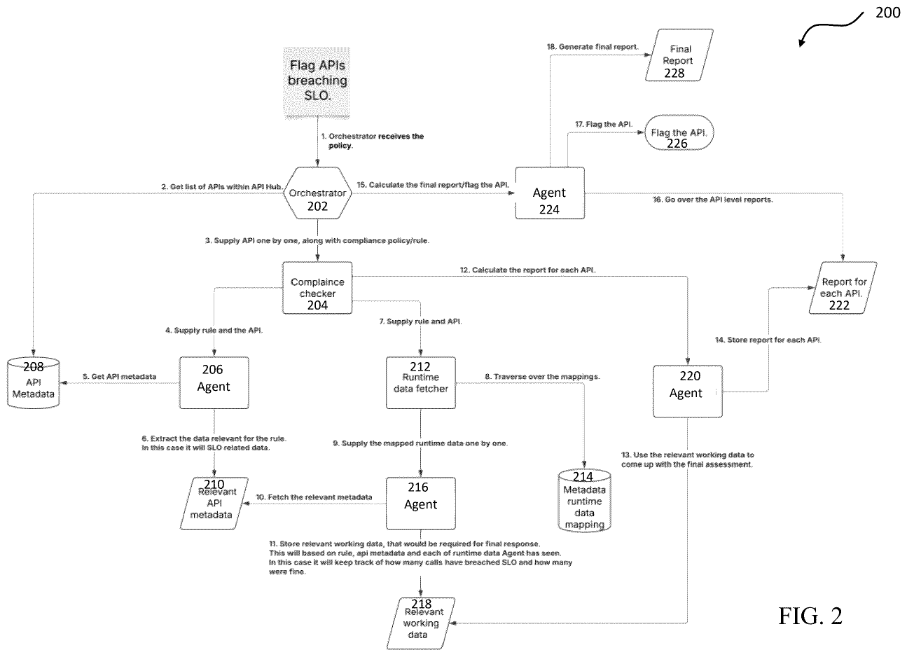

This mapping data may be used to iterate over all the APIs and their matching runtime data and check for policy/rule compliance. FIG. 2 illustrates one configuration of agents for a compliance check. The time complexity of this process would be O(n*l) where ‘n’ is the number of APIs in the plurality of agents and ‘l’ is the number of mapped runtime data blocks. Optimization through batching and other techniques offers significant potential for improvement.

FIG. 2 presents a schematic diagram depicting agents configured for a compliance check. The process can begin when the orchestrator agent 202 receives a policy or rule that needs to be enforced. The orchestrator agent 202 can be configured to serve as the central coordinator for the entire compliance verification workflow. The orchestrator agent 202 can be configured to distribute tasks to specialized agents.

After receiving the policy, the orchestrator agent 202 can retrieve a list of all APIs from the API hub and then processes each API by supplying it, along with the compliance policy/rule, to the compliance checker agent 204. The compliance checker 204 then can be configured to initiate processing paths for both metadata and runtime data analysis. For metadata processing, it supplies the rule and API identifier to a metadata agent 206, which can retrieve the corresponding API metadata 208 and extract the specific data relevant to the rule being evaluated 210. In the context of SLO compliance verification, this relevant metadata 210 can include expected response times, availability requirements, or error thresholds.

For runtime data processing, the compliance checker 204 supplies the rule and API identifier to the runtime data fetcher agent 212, which can traverse over the previously created mapping information 214 and supply the mapped runtime data one by one to another AI agent 216. The AI agent 216 can fetch the relevant metadata 210 and store the relevant working data 218 required for final analysis (step 11) in the working memory. This working memory tracks metrics such as how many API calls have breached SLOs and how many were within acceptable parameters.

Another AI agent 220 can be configured to calculate a comprehensive report for each API, using the relevant working data 218 to generate the final assessment. The AI agent 220 can store the individual API reports 222 based on the final assessment. The orchestrator 202 can provide the individual reports 222 to an AI agent 224 that calculates the final consolidated report 228. The AI agent 224 can be configured to process all the individual API reports 222, flag the APIs that are violating policies 226, and generate a final comprehensive report 228.

This orchestrated flow demonstrates the collaborative nature of the AI agent network, with each specialized component handling specific aspects of the analysis process. The use of working memory at multiple stages enables efficient data sharing between agents while maintaining focus on the most pertinent information for each processing stage.

### Dependency Graph Analysis

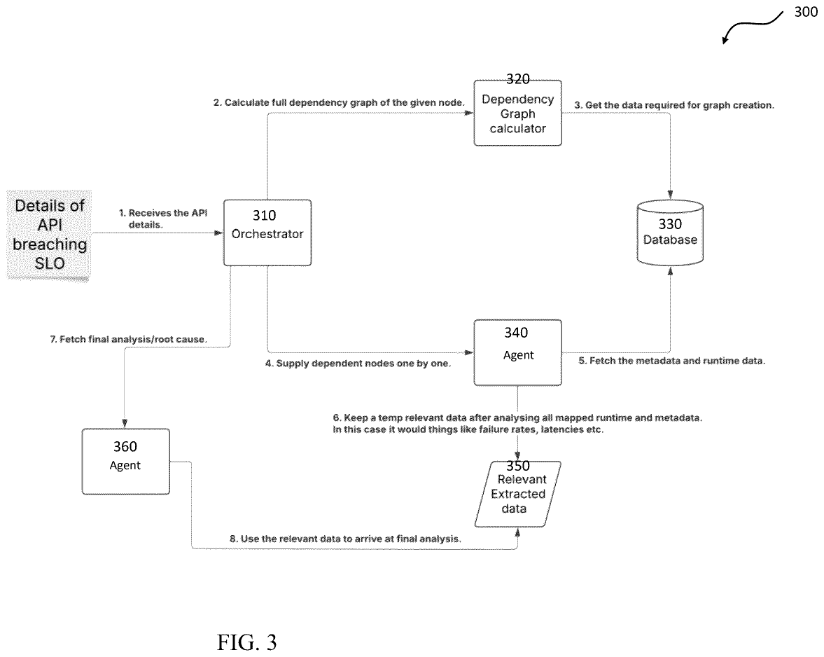

Dependency graph analysis may include utilizing the information derived from the compliance check, such as APIs not maintaining their SLO, to determine the root cause using dependency graph data. One example is illustrated in FIG. 3. The plurality of agents may take the flagged APIs as input, calculate the dependency graph for each flagged API, and determine the necessary information from each dependency and store this relevant data. The plurality of agents may utilize this data to present the root cause of the problem to the user.

FIG. 3 is a schematic diagram depicting agents configured for dependency graph analysis. As shown in FIG. 3, the workflow begins when the orchestrator agent 310 receives details about an API that is breaching its SLO. For example, the orchestrator agent 310 can receive this information from the policy compliance check 204 as shown in FIG. 2. The orchestrator 310 can be configured to communicate with the dependency graph calculator agent 320 to compute a full dependency graph of the given node with this information, which maps all upstream and downstream services that the problematic API depends on or that depend on it.

The dependency graph calculator retrieves the data for graph creation from the database 330, which includes service relationships, connection patterns, and historical performance metrics. The dependency graph can be stored in the API hub. With this dependency graph constructed, the orchestrator 310 then supplies each dependent node to an AI agent 340 for detailed analysis.

The AI agent 340 can access both metadata and runtime data stored in the database 330 for each dependency to evaluate how each connected service might be contributing to the SLO breach. During this analysis, the AI agent 340 can be configured to maintain temporary relevant data 350, including metrics such as failure rates, latencies, and other performance indicators that could signal potential issues within the dependency chain.

One of the AI agents 360 can fetch the final analysis results and utilize the relevant data 350 gathered throughout the process to determine the root cause of the SLO violation. This approach enables the system to not only identify which APIs are failing to meet their SLOs but also to trace these failures back to their underlying causes within complex service dependency networks.

### User Facing Agent

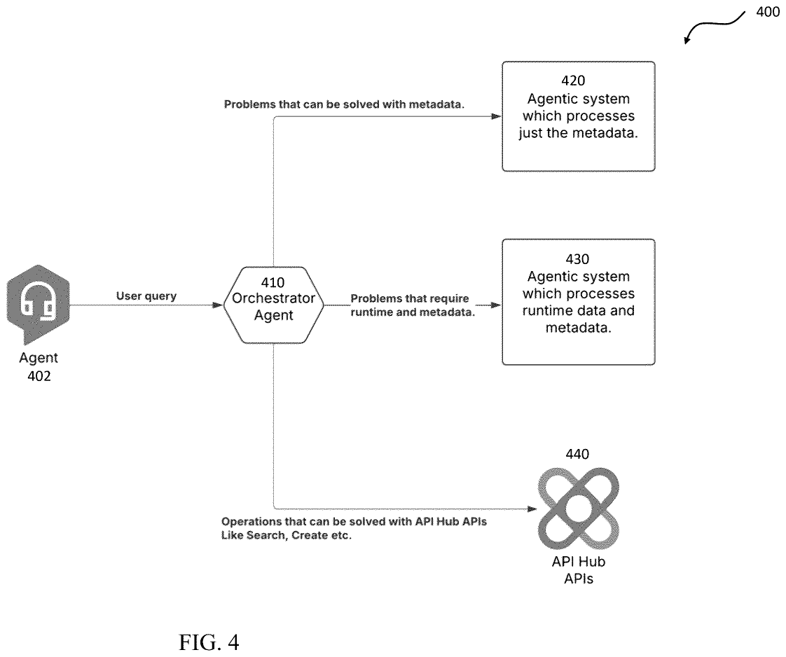

FIG. 4 is a schematic diagram 400 depicting an example configuration of a user facing agent, such as a third-party agent, can utilize various pre-existing agentic systems for different use cases. As one example, an agent can answer a query by iterating over API metadata, an agent can iterate over runtime data and metadata, and a user query can be resolved solely through a Semantic Search API call. An orchestrator may be powered by an agent or model to determine the intent of the user query and route it to the appropriate subsystem. For the first type of query, an agentic system may be used, but processing the runtime data may not be needed. For the second type of query, an agentic system may be used. The third type of query may be routed to semantic search.

As illustrated in FIG. 4, the user-facing agent 402 can be configured to provide an interface for users to interact with the network of the AI agents for API management. User queries are processed through an intelligent routing system centered around the orchestrator agent 410. When a user submits a query, the orchestrator agent 410 can be configured to analyze it to determine the appropriate processing path based on the query's requirements.

The orchestrator agent 410 can be configured to route queries to one of three distinct processing paths. For problems that can be solved using only API metadata, such as questions about API specifications or documentation, the query can be directed to an agentic system specialized for metadata processing 420. This approach optimizes efficiency by limiting the processing scope to metadata when runtime data analysis is unnecessary. For queries that require analysis of both runtime performance and metadata, the orchestrator 410 can direct them to an agentic system configured to process both types of information 430.

The third processing path addresses operations that can be resolved directly through existing API hub APIs 440, including search or create functions. In this case, the orchestrator agent 410 can route the query directly to the API Hub, bypassing additional AI agent processing when standard API operations can efficiently handle the request.

This intelligent routing architecture enables efficient handling of varied user queries by applying appropriate resources based on query complexity. The network of the AI agents optimizes resource utilization while providing comprehensive API management support by determining whether a query requires metadata analysis, combined runtime and metadata analysis, or direct API operations.

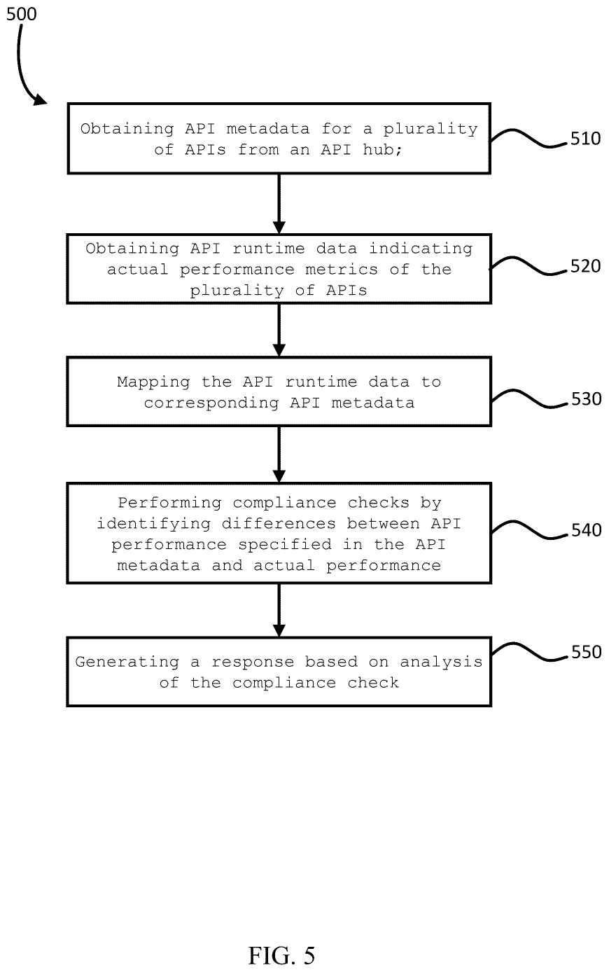

FIG. 5 depicts flow diagrams of an example process of managing APIs for a compliance check according to aspects of the disclosure. The example process 500 can be performed on the plurality of AI agents. While the operations are described in a particular order below, the order may be modified and operations may be performed in parallel. Moreover, operations may be added or omitted.

As shown in block 510, the network of AI agents can obtain API metadata for a plurality of APIs from an API hub. The API metadata can be obtained by a metadata agent within the network of AI agents. As shown in block 520, the network of AI agents can obtain API runtime data indicating actual performance metrics of the plurality of APIs by a runtime data fetcher agent.

As shown in block 530, one of the agents within the network of AI agents can map the API runtime data to corresponding API metadata. This mapping data may be used to iterate over all the APIs and their matching runtime data and check for policy or rule compliance.

As shown in block 540, the network of AI agents can perform compliance checks by identifying differences between the API performance specified in the API metadata and actual performance. The compliance checker agent orchestrates the evaluation process by distributing tasks to specialized agents, which compare actual performance metrics against defined thresholds in the API metadata to detect SLO violations and policy non-compliance.

As shown in block 550, the network of AI agents generates a response based on analysis of the compliance check. This response may include flagging APIs that violate policies, generating comprehensive reports for each API, and providing detailed analysis results through the user-facing agent that identifies specific compliance violations and their technical causes within the API hub.

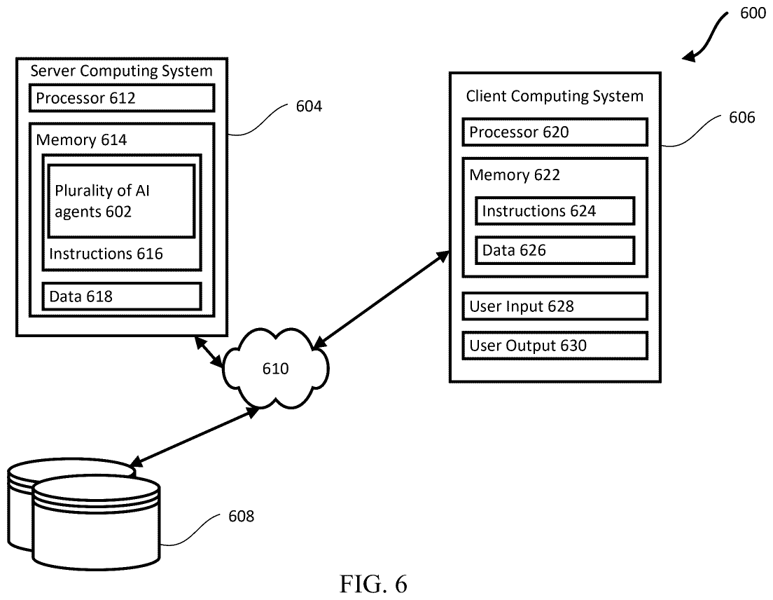

FIG. 6 depicts a block diagram of an example computing environment 600 implementing an example server computing system 604. The system can be implemented through the system, which provides tools and environments to implement and run the system. The server computing system 604 can be implemented on one or more devices having one or more processors in one or more locations, such as in server computing device 604. The system can include one or more AI/ML agents, engines, modules, or models 602. The AI/ML engines, modules, or models can be implemented as one or more computer programs, specially configured electronic circuitry, or any combination thereof. The AI/ML agents, engines, modules, or models can be configured to collaborate with each other to implement a network to manage APIs.

User computing system 606 and the server computing device 604 can be communicatively coupled to one or more storage devices 608 over a network 610. The storage devices 608 can be a combination of volatile and non-volatile memory and can be at the same or different physical locations than the computing systems 604, 606. For example, the storage device(s) 608 can include any type of non-transitory computer readable medium capable of storing information, such as a hard-drive, solid state drive, tape drive, optical storage, memory card, ROM, RAM, DVD, CD-ROM, write-capable, and read-only memories. Cloud storage is a mode of computer data storage in which digital data is stored on one or more storage devices 608 over a network 610.

The server computing device 604 can include one or more processors 612 and memory 614. The memory 614 can store information accessible by the processors 612, including instructions 616 that can be executed by the processors 612. The memory 614 can also include data 618 that can be retrieved, manipulated, or stored by the processors 612. The memory 614 can be a type of transitory or non-transitory computer readable medium capable of storing information accessible by the processors 612, such as volatile and non-volatile memory. The processors 612 can include one or more central processing units (CPUs), graphic processing units (GPUs), field-programmable gate arrays (FPGAs), and/or application-specific integrated circuits (ASICs), such as tensor processing units (TPUs).

The instructions 616 can include one or more instructions that, when executed by the processors 612, cause the one or more processors 612 to perform actions defined by the instructions 616. The instructions 616 can be stored in object code format for direct processing by the processors 612, or in other formats including interpretable scripts or collections of independent source code modules that are interpreted on demand or compiled in advance. The instructions 616 can include instructions for implementing server computing system 604. The server computing system 604 can be executed using the processors 612, and/or using other processors remotely located from the server computing device 604.

The data 618 can be retrieved, stored, or modified by the processors 612 in accordance with the instructions 616. The data 618 can be stored in computer registers, in a relational or non-relational database as a table having a plurality of different fields and records, or as JSON, YAML, proto, or XML documents. The data 618 can also be formatted in a computer-readable format such as, but not limited to, binary values, ASCII or Unicode. Moreover, the data 618 can include information sufficient to identify relevant information, such as numbers, descriptive text, proprietary codes, pointers, references to data stored in other memories, including other network locations, or information that is used by a function to calculate relevant data.

The user computing system 606 can also be configured similar to the server computing device 604, with one or more processors 620, memory 622, instructions 624, and data 626. The user computing system 606 can also include a user input 628, and a user output 630. The user input 628 can be the user queries in FIG. 4.

The server computing device 604 can be configured to transmit data to the user computing system 606, and the user computing system 606 can be configured to display at least a portion of the received data on a display implemented as part of the user output 630. The user output 630 can also be used for displaying an interface between the user computing system 606 and the server computing device 604. The user output 630 can alternatively or additionally include one or more speakers, transducers or other audio outputs, a haptic interface or other tactile feedback that provides non-visual and non-audible information to the user of the user computing system 606.

Although FIG. 6 illustrates the processors 612, 620 and the memories 614, 622 as being within the computing systems 604, 606, components described herein, including the processors 612, 620 and the memories 614, 622 can include multiple processors and memories that can operate in different physical locations and not within the same computing device. For example, some of the instructions 616, 624 and the data 618, 626 can be stored on a removable SD card and others within a read-only computer chip. Some or all of the instructions 616, 624 and data 618, 626 can be stored in a location physically remote from, yet still accessible by, the processors 612, 620. Similarly, the processors 612, 620 can include a collection of processors that can perform concurrent and/or sequential operations. The computing systems 604, 606 can each include one or more internal clocks providing timing information, which can be used for time measurement for operations and programs run by the computing systems 604, 606.

The server computing device 604 can be configured to receive requests to process data from the user computing system 606. For example, the environment 600 can be part of a computing platform configured to provide a variety of services to users, through various user interfaces and/or APIs exposing the platform services. One or more services can be a machine learning framework or a set of tools for generating neural networks or other machine learning models according to a specified task and training data. The user computing system 606 may receive and transmit data specifying target computing resources to be allocated for executing a neural network trained to perform a particular neural network task.

The computing systems 604, 606 can be capable of direct and indirect communication over the network 610. The computing systems 604, 606 can set up listening sockets that may accept an initiating connection for sending and receiving information. The network 610 can include various configurations and protocols including the Internet, World Wide Web, intranets, virtual private networks, wide area networks, local networks, and private networks using communication protocols proprietary to one or more companies. The network 610 can support a variety of short-and long-range connections. The short-and long-range connections may be made over different bandwidths, such as 2.402 GHz to 2.480 GHz (commonly associated with the Bluetooth® standard), 2.4 GHz and 5 GHz (commonly associated with the Wi-Fi® communication protocol); or with a variety of communication standards, such as the LTE® standard for wireless broadband communication. The network 610, in addition or alternatively, can also support wired connections between the computing systems 604, 606, including over various types of Ethernet connection.

Although a single server computing device 604 and user computing systems 606 are shown in FIG. 6, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

Aspects of this disclosure can be implemented in digital circuits, computer-readable storage media, as one or more computer programs, or a combination of one or more of the foregoing. The computer-readable storage media can be non-transitory, e.g., as one or more instructions executable by a cloud computing platform and stored on a tangible storage device.

In this specification, the phrase “configured to” is used in different contexts related to computer systems, hardware, or part of a computer program, engine, or module. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program, engine, or module is said to be configured to perform one or more operations, this means that the computer program includes one or more program instructions, that when executed by one or more computers, causes the one or more computers to perform the one or more operations.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for managing application programming interfaces (APIs) using a network of one or more artificial intelligence (AI) agents, the method comprising:
obtaining, with one or more processors by the network of one or more AI agents, API metadata for a plurality of APIs from an API hub;
obtaining, with the one or more processors, API runtime data indicating actual performance metrics of the plurality of APIs;
mapping, with the one or more processors, the API runtime data to corresponding API metadata;
performing, with the one or more processors, compliance checks by identifying differences between API performance specified in the API metadata and actual performance; and
generating, with the one or more processors, a response based on analysis of the compliance check.

2. The method of claim 1, wherein the network of AI agents comprises a plurality of specialized AI agents, each specialized AI agent being configured to perform a specific function for managing API.

3. The method of claim 1, further comprising: determining, with the one or more processors, service level objective (SLO) violations based on the identified differences between the API performance specified in the API metadata and the actual performance.

4. The method of claim 3, further comprising:
calculating, with the one or more processors, dependency for APIs identified as violating SLOs; and
analyzing, with the one or more processors, the dependency to determine root causes of the SLO violations.

5. The method of claim 2, further comprising: storing, in a shared memory accessible by the plurality of specialized AI agents, results of the compliance checks and analysis.

6. The method of claim 5, wherein the shared memory enables information sharing between the plurality of specialized AI agents in a cascading manner, wherein output from one AI agent serves as input to another agent.

7. The method of claim 2, further comprising:
receiving, with the one or more processors, a user query related to API performance;
determining, with the one or more processors, an intent of the user query using a user-facing AI agent within the network of AI agents; and
routing, with the one or more processors, the user query to an appropriate specialized AI agent within the network based on the determined intent.

8. The method of claim 1, wherein the API metadata comprises at least one of API specifications, policies, expected response times, availability requirements, security requirements, or dependency information.

9. The method of claim 1, wherein the API runtime data comprises at least one of error rates, actual response times, traffic volume, availability metrics, or security incidents.

10. The method of claim 1, wherein the compliance checks include at least one of policy compliance verification, dependency analysis, or root cause analysis of performance issues.

11. A system for managing application programming interfaces (APIs), the system comprising:
one or more processors; and
a memory storing instructions that, when executed by the one or more processors, cause the system to implement a network of AI agents configured to:
obtain API metadata for a plurality of APIs from an API hub;
obtain API runtime data indicating actual performance metrics of the plurality of APIs;
map the API runtime data to corresponding API metadata;
perform compliance checks by identifying differences between API performance specified in the API metadata and actual performance; and
generate a response based on analysis of the compliance check.

12. The system of claim 11, wherein the network of AI agents comprises a plurality of specialized AI agents, each specialized AI agent being configured to perform a specific function for managing API.

13. The system of claim 12, wherein the specialized AI agents include a policy compliance agent configured to determine service level objective (SLO) violations based on the identified differences between the API performance specified in the API metadata and the actual performance.

14. The system of claim 13, wherein the specialized AI agents include an analysis agent configured to:
calculate dependency for APIs identified as violating SLOs; and
analyze the dependency to determine root causes of the SLO violations.

15. The system of claim 12, wherein the network of AI agents is further configured to store results of the compliance checks and analysis in a shared memory accessible by the plurality of specialized AI agents.

16. The system of claim 15, wherein the shared memory enables information sharing between the plurality of specialized AI agents in a cascading manner, wherein output from one AI agent serves as input to another agent.

17. The system of claim 12, wherein the specialized AI agents include a user-facing agent configured to:
receive a user query related to API performance;
determine an intent of the user query using a user-facing AI agent within the network of AI agents; and
route the user query to an appropriate specialized AI agent within the network based on the determined intent.

18. The system of claim 11, wherein the API metadata comprises at least one of API specifications, policies, expected response times, availability requirements, security requirements, or dependency information.

19. The system of claim 11, wherein the API runtime data comprises at least one of error rates, actual response times, traffic volume, availability metrics, or security incidents.

20. The system of claim 11, wherein the compliance checks include at least one of policy compliance verification, dependency analysis, or root cause analysis of performance issues.
